(19) United States
(12) Patent Application Publication
(10) Pub. No.: US 2026/0063441 A1
(43) Pub. Date: Mar. 5, 2026

(54) INTELLIGENT PARKING GUIDANCE SYSTEM

(71) Applicant: Junfeng Zhao, Chandler, AZ (US)

(72) Inventor: Junfeng Zhao, Chandler, AZ (US)

(21) Appl. No.: 19/300,479

(22) Filed: Aug. 14, 2025

Related U.S. Application Data
(60) Provisional application No. 63/688,724, filed on Aug. 29, 2024.

(51) Int. Cl. G01C 21/36; G01C 21/34

(52) U.S. Cl. CPC G01C 21/3685; G01C 21/3446; G01C 21/3602; G01C 21/3647

(57) ABSTRACT

Methods and systems for intelligent parking are disclosed. Exemplary methods include detecting, a plurality of parking spaces contained in a digital image of a parking lot, creating a database containing entries for each of the plurality of parking spaces contained in the digital image, determining which parking spaces in the plurality of parking spaces are unoccupied, receiving, from a mobile device of a user, a request for an unoccupied parking space, calculating which unoccupied parking space in the plurality of parking spaces is located closest to the user, and transmitting to the mobile device of the user, graphical directions for use in navigating a vehicle of the user to the closest unoccupied parking space.

### CROSS REFERENCE TO RELATED APPLICATIONS

This application is a non-provisional of and claims priority to, and the benefit of, U.S. Provisional Patent Application Ser. No. 63/688,724 filed Aug. 29, 2024, entitled “INTELLIGENT PARKING GUIDANCE SYSTEM.” The foregoing application is hereby incorporated by reference in its entirety, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to navigation, and particularly to navigation of vehicles in connection with parking.

### BACKGROUND

Urban areas'constant growth and the number of cars accompanying them have created various difficulties, including parking, which is becoming a more pressing problem. The demand for parking in public locations is overwhelming, causing traffic jams inside the parking lots. Vehicle users often find it difficult to find a vacant parking space. Previous attempts to address such issues included using technology to identify if there are any vacant parking spaces in a particular parking lot and using an electronic board to display the number of available parking spaces in that lot. In this case, the system only tells the user if there are any available spaces to park their vehicle. In this scenario, the user is motivated to enter a parking lot to park their vehicle, hoping to find a parking space, but would still have to search for the vacant space by circling the parking lot. Previous attempts fail to reduce greenhouse gas emissions and environmental pollution. Additionally, in crowded lots, while searching for parking spaces, users often become inattentive to their surroundings and end up in a traffic accident. Accordingly, improved approaches for parking systems remain highly desirable.

### SUMMARY

Various embodiments of the present disclosure relate to methods of intelligent parking. While the ways in which various embodiments of the present disclosure address drawbacks of prior methods and systems are discussed in more detail below, in general, exemplary embodiments of the disclosure provide improved methods and systems for intelligently managing and providing parking in a parking lot. Exemplary methods provide desired reduction in greenhouse gas emissions, traffic accidents, and user time lost searching for an unoccupied parking space.

In accordance with various embodiments of the disclosure, methods of intelligent parking are provided. Exemplary methods can include detecting, by a computer-based intelligent parking system, a plurality of parking spaces contained in a digital image of a parking lot, creating, by the intelligent parking system, a database containing entries for each of the plurality of parking spaces contained in the digital image, determining, by the intelligent parking system, which parking spaces in the plurality of parking spaces are unoccupied, receiving, by the intelligent parking system and from a mobile device of a user, a request for an unoccupied parking space, calculating, by the intelligent parking system, which unoccupied parking space in the plurality of parking spaces is located closest to the user, and transmitting, by the intelligent parking system and to the mobile device of the user, graphical directions for use in navigating a vehicle of the user to the closest unoccupied parking space.

In various embodiments, the detecting may utilize a polygon-point intersection algorithm. The database may contain information regarding the latitude and longitude of each parking space. The database may contain position information for each parking space relative to a digital camera that produced the digital image. The database may comprise a unique identifier associated with each parking space. The graphical directions may comprise Google Maps API information. The graphical directions may comprise an overlay of parking lot information onto a digital image of the parking lot. The graphical directions may be based, at least in part, on the presence of non-parked vehicles other than the user's vehicle within the parking lot. The graphical directions may be provided such that the user's vehicle and another non-parked vehicle do not follow overlapping paths. The determining may utilize a machine learning algorithm. Exemplary methods may further comprise updating the database to reflect the closest parking space is now occupied by the vehicle.

Exemplary methods may include receiving, by the intelligent parking system, a digital image of the parking lot from an imaging system. The imaging system may comprise a plurality of digital cameras. Each of the plurality of digital cameras may provide a digital image to the intelligent parking system. The detecting a plurality of parking spaces and the determining which parking spaces in the plurality of parking spaces are unoccupied may be based on each of the digital images. The determining which parking spaces in the plurality of parking spaces are unoccupied can include determining, by the intelligent parking system, a first distance from a first of the plurality of digital cameras to a parking space of the plurality of parking spaces, calculating, by the intelligent parking system, a first weight based on the first distance, assigning, by the intelligent parking system, the first weight to the first of the plurality of digital cameras, determining, by the intelligent parking system, a second distance from a second of the plurality of digital cameras to the parking space, calculating, by the intelligent parking system, a second weight based on the second distance, assigning, by the intelligent parking system, the second weight to the second of the plurality of digital cameras, generating, by the intelligent parking system, a first indication of whether the parking space is unoccupied based on a first digital image provided by the first of the plurality of digital cameras, generating, by the intelligent parking system, a second indication of whether the parking space is unoccupied based on a second digital image provided by the second of the plurality of digital cameras, and determining, based on the first indication, the first weight, the second indication, and the second weight, whether the parking space is unoccupied. The determining can further include modifying the first indication by the first weight, modifying the second indication by the second weight, and calculating a weighted average indication of whether the parking space is unoccupied based on the modified first indication and the modified second indication.

In various embodiments, the calculating which unoccupied parking space in the plurality of parking spaces is located closest to the user can include determining, by the intelligent parking system, a distance from the user to each of the unoccupied parking spaces in the plurality of parking spaces, sorting, by the intelligent parking system, each of the unoccupied parking spaces in the plurality of parking spaces by the distance and selecting, by the intelligent parking system, the unoccupied parking space with the shortest distance. The calculating which unoccupied parking space in the plurality of parking spaces is located closest to the user can further include receiving, by the intelligent parking system and from a mobile device of the user, an indication that the user has deviated from the graphical directions, recalculating, by the intelligent parking system, which unoccupied parking space in the plurality of parking spaces is located closest to the user, and transmitting, by the intelligent parking system and to the mobile device of the user, recalculated graphical directions for use in navigating the vehicle of the user to the closest unoccupied parking space.

Exemplary methods can include detecting, by the intelligent parking system, a change in an occupation status of at least one of the closest unoccupied parking space or an occupied parking space within the plurality of parking spaces that is closer to the user than the closest unoccupied parking space, recalculating, by the intelligent parking system, which unoccupied parking space in the plurality of parking spaces is located closest to the user, and transmitting, by the intelligent parking system and to the mobile device of the user, updated graphical direction for use in navigating the vehicle of the user to the updated closest unoccupied parking space.

In accordance with further exemplary embodiments of the disclosure, a system for facilitating parking is provided. The system may be used for performing a method disclosed herein. The system may include a digital camera and an intelligent parking system. The digital camera can be configured to provide a digital image of a plurality of parking spaces. The intelligent parking system can include one or more non-transitory, tangible computer readable storage mediums having instructions stored thereon that, in response to execution by one or more processors, cause the one or more processors to detect a plurality of parking spaces contained in the digital image, create a database containing entries for each of the plurality of parking spaces contained in the digital image, determine which parking spaces in the plurality of parking spaces are unoccupied, receive, from a mobile device of a user, a request for an unoccupied parking space, calculate which unoccupied parking space in the plurality of parking spaces is located closest to the user, and transmit, to the mobile device of the user, graphical directions for use in navigating a vehicle of the user to the closest unoccupied parking space.

These and other embodiments will become readily apparent to those skilled in the art from the following detailed description of certain embodiments having reference to the attached figures; the invention not being limited to any particular embodiment(s) disclosed.

### BRIEF DESCRIPTION OF THE DRAWINGS

With reference to the following description and accompanying drawings:

FIG. 1 illustrates a method for intelligent parking, in accordance with various exemplary embodiments;

FIG. 2 illustrates architecture of an exemplary parking guidance system, in accordance with various exemplary embodiments;

FIG. 3 illustrates an exemplary image of a plurality of parking spaces for use in an exemplary parking guidance system, in accordance with various exemplary embodiments;

FIG. 4 illustrates defining an occupation status of parking spaces in an exemplary parking guidance system, in accordance with various exemplary embodiments;

FIG. 5 illustrates an exemplary user interface in an exemplary parking guidance system, in accordance with various exemplary embodiments;

FIG. 6 illustrates an exemplary user interface in an exemplary parking guidance system, in accordance with various exemplary embodiments;

FIG. 7 illustrates an exemplary data pipeline in an exemplary parking guidance system, in accordance with various exemplary embodiments;

FIG. 8 illustrates an exemplary software interface architecture in an exemplary parking guidance system, in accordance with various exemplary embodiments;

FIG. 9 illustrates exemplary real-time routing of a user's vehicle in an exemplary parking guidance system, in accordance with various exemplary embodiments;

FIG. 10 illustrates an exemplary parking guidance system, in accordance with various exemplary embodiments; and

FIG. 11 illustrates an exemplary occupancy status chart in an exemplary parking guidance system, in accordance with various exemplary embodiments; and

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the present disclosure.

Many parking lots worldwide have implemented a smart parking system that provides information about the available parking spaces at each instant, but without guiding the drivers to these spaces. In contrast, the present disclosure describes an innovative intelligent parking system that not only monitors the parking lot using an infrastructure monocular camera to identify the number of available parking spaces but also pinpoints the location of these spaces in the parking lot. It then provides the driver with a navigation route to the nearest available parking space from their location at each instance. Experimental results demonstrate that this innovative, intelligent parking guidance solution can significantly simplify the parking process for human drivers, making it safer by reducing the risk of accidents and making it more convenient and environmentally friendly.

The existing parking lot solutions do not have real-time navigation to the nearest parking space; they can provide data about the number of empty parking spaces in the parking lot. The innovations disclosed herein hold an advantage over the existing solutions by providing information about the location of these empty parking spaces, finding the nearest empty parking space from the user, and providing real-time navigation from the user's location to that parking space, which makes exemplary embodiments unique and highly convenient to human drivers. A novel intelligent parking system is provided herein that utilizes edge computing and computer vision with a single monocular camera infrastructure and/or a multi camera infrastructure. This system provides real-time operation for efficient navigation and space management, and may reduce latency through on-site data processing using edge computing. The system may send processed video data to a driver-accessible online interface. Parking lot statuses can be remotely monitored by the system. The system can incorporate a dynamic navigation system which may use the driver's current location in the parking lot to direct them to the closest open parking space. By cutting down on the amount of time spent looking for parking, lowering the possibility of accidents, and lessening the effect that vehicle emissions have on the environment, such a system has the potential to transform the parking experience.

The present disclosure thus addresses both the operational inefficiencies in contemporary parking lots and the environmental and safety concerns exacerbated by current parking practices. Exemplary systems described herein significantly enhances the parking experience, aligning with broader environmental and safety goals by offering a seamless, user-friendly interface that provides real-time updates and navigational assistance.

The most common form of transportation in the United States is private transportation. Typically, each house in America has at least one car. As per the Bureau of Transport Statistics (National Household Travel Survey Daily Travel Quick Facts 2017), 87% of daily trips occur in personal vehicles, and 91% of people commuting to work use personal vehicles. Americans take 1.1 billion daily trips, four for every person in the U.S. Daily travel averages 11 billion miles a day, almost 40 miles per person. 45% of daily trips are taken for shopping and errands. As per the statistics provided by EZ Auto Spa, 10 interesting accidents in parking lots were reported in 2023, and Noyes (2017) that parking lots pose significant risks, with 1 in 5 vehicle accidents occurring there, resulting in over 500 annual deaths and around 50,000 accidents in the U.S., per OBE Law (2018). These accidents also lead to over 60,000 injuries, ranging from minor to severe, and 25% of them involve vehicles backing up. Distracted driving is a prevalent issue, with one-third of drivers admitting to not paying attention while driving in parking lots. Moreover, minor damage like bumper scratches is typical, accounting for at least 80% of incidents, with 14% of all car insurance claims related to parking lot accidents. Peak accident times are Saturdays at 5:00 PM, and the holiday shopping season sees a spike in accidents due to crowded lots and increased stress. Therefore, vigilance and caution are crucial in parking lots to prevent accidents. Finding a parking space in public places like shopping malls or downtown areas takes a lot of work. The average American driver wastes 17 hours every year searching for parking. That adds up to $73 billion in lost time, fuel, and emissions searching for parking across all drivers nationally. An intelligent standard parking system can help to overcome most of the driver's problems in searching for parking spaces.

Finding an open parking space at congested parking lots in urban centers, commercial areas, and public spaces is often time-consuming and frustrating, leading to wasted fuel and increased greenhouse gas emissions. Another concern in parking lots is the occurrence of traffic accidents, usually caused by distracted drivers searching for parking spaces or navigating through congested lots. It is challenging for human drivers and robot taxis or vehicles that can be summoned to parking lots. An innovative navigation solution to ease the parking process for human drivers and autonomous vehicles (AVs) and make it safer, more convenient, and environmentally friendly is desired. Exemplary embodiments disclosed herein solve the above-mentioned problems by finding the location of the nearest available/empty parking space in a parking lot. Exemplary embodiments can provide real-time navigation for users from their current location to the nearest empty parking space. An exemplary embodiment uses an open-source Machine Learning algorithm to perform object detection, for example using YOLOV5 architecture. The ML algorithm is trained on an open-source dataset named COCO, and exemplary embodiments have customized the ML algorithm to detect all types of cars. Finally, exemplary embodiments can use Computer Vision techniques to detect the empty parking spaces in the parking lot.

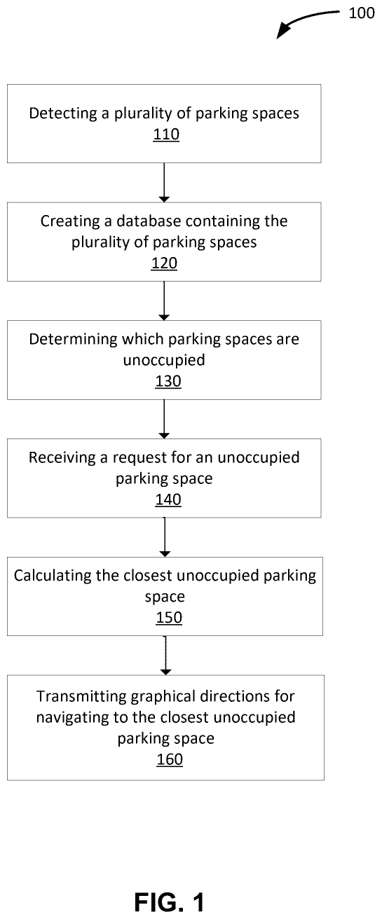

Turning now to the figures, FIG. 1 illustrates a method for intelligent parking. Method 100 can be performed by an intelligent parking system and can include detecting a plurality of parking spaces contained in a digital image of a parking lot (step 110), creating a database containing entries for each of the plurality of parking spaces contained in the digital image (step 120), determining which parking spaces in the plurality of parking spaces are unoccupied (step 130), receiving, from a mobile device of a user, a request for an unoccupied parking space (step 140), calculating which unoccupied parking space in the plurality of parking spaces is located closest to the user (step 150), and transmitting, to the mobile device of the user, graphical directions for use in navigating a vehicle of the user to the closest unoccupied parking space (step 160).

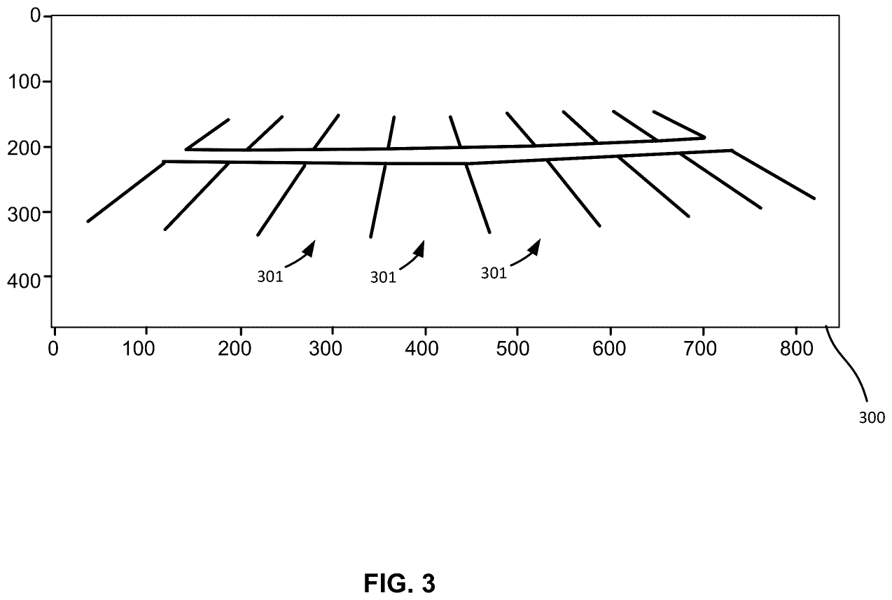

Step 110 can include detecting a plurality of parking spaces contained in a digital image of a parking lot. For example, the intelligent parking system may receive a digital image of a parking lot and/or of a plurality of parking spaces. The intelligent parking system may use image processing techniques, such as for example edge detection and the Hough transform, to define regions of interest (i.e., parking spaces) for monitoring and/or to extract coordinates of the parking spaces from the digital image. The detecting can be adaptable. For example, the detecting may utilize computer vision, machine learning, and image processing techniques. In various embodiments, parking spaces may be detected using Bresenham's Algorithm and/or may be defined manually at a setup step for an intelligent parking system. In embodiments employing a manual setup step, defining parking spaces manually may be performed once at the initial intelligent parking system setup. With momentary reference to FIG. 3, a digital image 300 may include a plurality of parking spaces 301.

The intelligent parking system may receive the digital image from an imaging system. The imaging system may include, for example, a single digital camera. The digital camera may be configured to provide digital images of a parking lot and/or a plurality of parking spaces every 60 seconds, every 30 seconds, every 15 seconds, every 5 seconds, every 2 seconds, every second, and/or continuously (i.e., video). In various embodiments, the imaging system may comprise a plurality of digital cameras. Each digital camera may be configured to provide a digital image to the intelligent parking system. The digital camera may be any digital camera. By way of particular example, the digital camera may be a GoPro camera, such as the GoPro Hero 10. The imaging system and/or the digital camera(s) may be configured such that the digital image(s) provide visibility of all parking spaces within the parking lot and/or within the plurality of parking spaces. In various embodiments, a setup step for an intelligent parking system may include positioning one or more digital cameras such that the one or more digital cameras are configured to monitor each of a plurality of parking spaces.

Step 120 can include creating a database containing entries for each of the plurality of parking spaces contained in the digital image. The database may be any suitable type of database. By way of particular example, the database may be a NoSQL database. The database can store a latitude of each parking space, a longitude of each parking space, position information for each parking space relative to a digital camera (i.e., distance), position information for each parking space relative to an entrance and/or exit of a parking lot, occupancy status of each parking space, a unique identifier for each parking space, and/or any other suitable or desired information.

Step 130 can include determining which parking spaces in the plurality of parking spaces are unoccupied. The determining can include obtaining the coordinates of a parking space and/or obtaining the coordinates of a car. The coordinates of the parking space may be obtained from the database and/or from the digital image. The coordinates of the parking space may be local (i.e., relative to the digital camera) and/or global (i.e., latitude and longitude). Local coordinates may provide for the position of the parking spaces relative to the camera, which may be desirable for determining a distance or for navigation to the parking spaces. Global coordinates may provide for integration with navigation and/or mapping services, such as Google Maps API services. Global coordinates for parking spaces and/or for an entrance to a parking lot may be obtained manually and input into the intelligent parking system. The coordinates of a parking spaces may be mapped to the parking space's unique identifier within the database. The coordinates of the car may be obtained by an object detection computer model. For example, the coordinates of the car may be obtained by a You Only Look Once (YOLO) computer vision model, such as Yolov5. The object detection model may divide the digital image into a grid, where each grid may be responsible for detecting objects within its area. The object detection model may detect cars of any shape, color, and/or size, and may have a detection accuracy of greater than 50%, greater than 75%, greater than 90%, or about 94%.

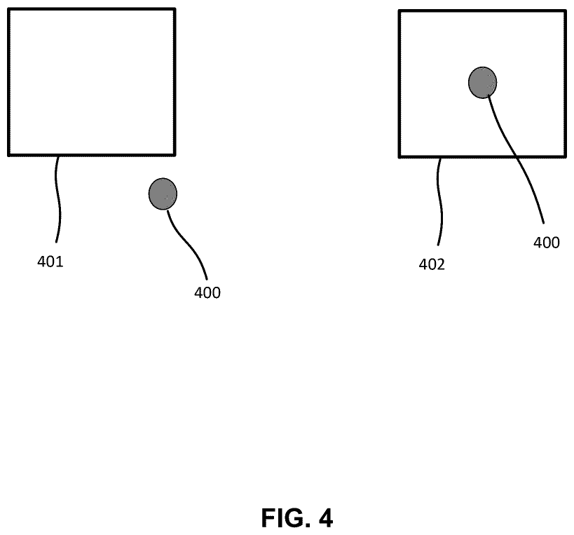

Step 130 can further include calculating the Intersection over the Union (IoU) between the parking space and the car. Calculating the IoU may be based on the coordinates of the parking space and the coordinates of the car. By way of particular example, an IoU Ray Casting Algorithm may use a polygon-point method to calculate the IoU value. The car's central point may be calculated. The intelligent parking system may determine whether the car's central point is positioned inside, outside, or on the polygon defined by the coordinates of the parking space. The IoU value may be calculated based on the car's central point's position relative to the polygon (i.e., inside, outside, or on the polygon). For example, if the IoU value is greater than or equal to 50%, the intelligent parking system may determine that the parking space is occupied. With momentary reference to FIG. 4, a car 400 is illustrated outside of an unoccupied space 401 that the intelligent parking system has determined is unoccupied. A car 400 is illustrated inside of an occupied space 402 that the intelligent parking system has determined is occupied.

In various embodiments including multiple digital cameras, the IoU value may be calculated for each parking space and each car with respect to each digital image provided by each digital camera. The IoU value may be calculated by IoU=(I_{A}/ U_{A}), where I_{A} is the intersection area (i.e., the overlap area between the vehicle and the parking space, and where U_{A} is the total area covered by both the vehicle and the parking space minus the intersection area. first distance from a first of the digital cameras to a parking space may be determined. A second distance from a second of the digital cameras to the parking space may be determined. The intelligent parking system may calculate a statistical weight for the first IoU value computed by the digital image from the first digital camera based on the first distance. The intelligent parking system may calculate a second statistical weight for the second IoU value computed from the digital image from the second digital camera based on the second distance. A weighted average may be calculated based on each IoU value and each corresponding statistical weight. For example, the first IoU value may be modified by the first statistical weight, the second IoU value may be modified by the second statistical weight, and the weighted average may be calculated by the modified first and second IoU values, for example by the formula Weighted Average IoU=Σⁿᵢ₌₁ (Wᵢ×IoUᵢ), where Wi is the normalized weight of camera i, IoUi is the IoU value from camera i, and n is the number of cameras covering that parking space. Wi may be calculated by the equation Wᵢ=[(1/Dᵢ)/(υⁿⱼ₌₁ 1/Dⱼ)], where Di represents the distance from the camera to the parking space and where Dj represents the distance from alternative digital cameras to the parking space. In this manner, a greater weight is provided to a digital camera located closer to a parking space compared to a digital camera which is further away. In various embodiments, the parking space may be determined to be occupied if the IoU is 0.45 or greater. The intelligent parking system may utilize data from each of the digital cameras in determining whether a parking space is occupied, and may resolve conflicting determinations by distinct digital cameras.

Step 130 may be repeated during method 100 or during operation of an intelligent parking system. For example, Step 130 may be performed every 60 seconds, 30 seconds, 15 seconds, 10 seconds, 5 seconds, 2 seconds, every second, or continuously. In this manner, the occupancy status of each of the parking spaces may be updated in the database in real time.

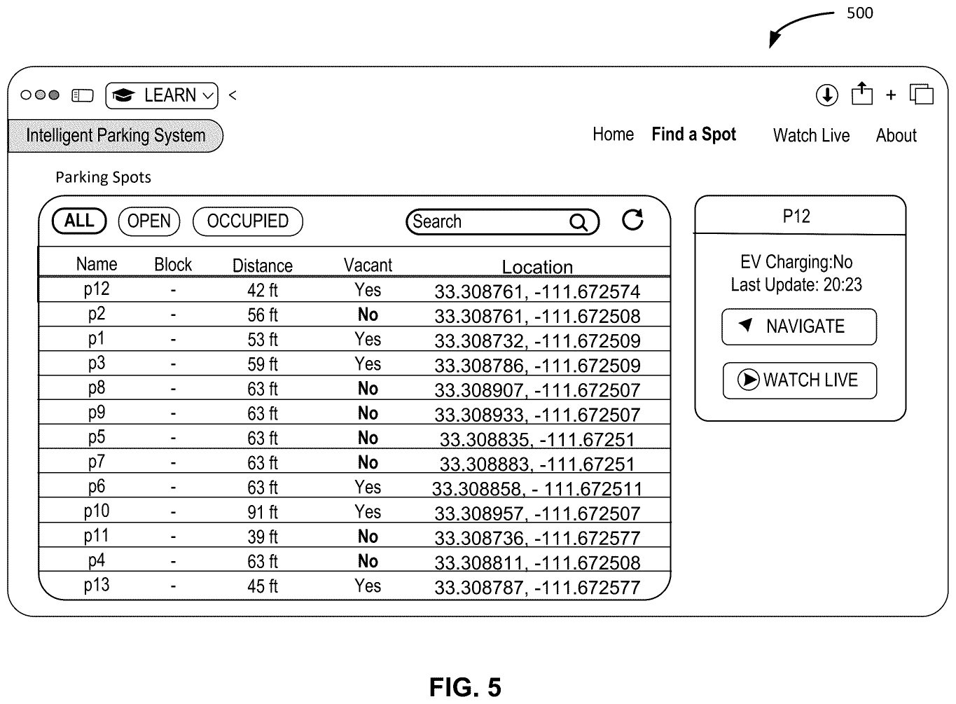

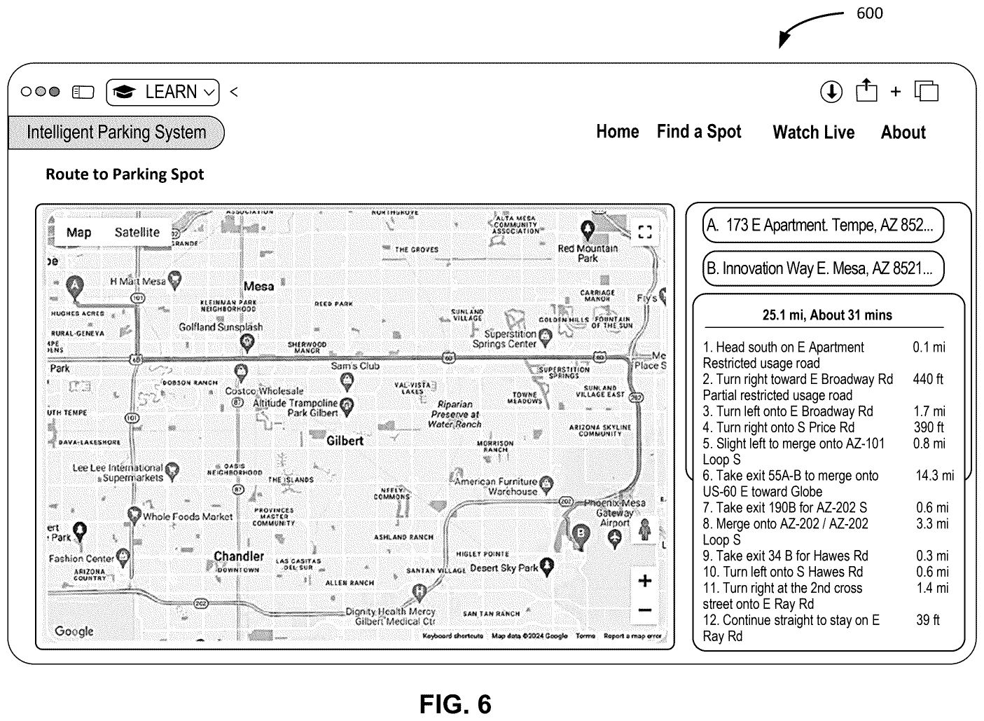

Step 140 can include receiving, from a mobile device of a user, a request for an unoccupied parking space. The user may submit the request via a user interface. With momentary reference to FIGS. 5 and 6, exemplary user interfaces 500 and 600 are provided. The user interface may provide relevant information regarding the parking lot and/or the plurality of parking spaces, such as distance and occupation status, and a user may select to navigate to a parking space. The user interface may suggest a parking space to the user, such as for example the closest unoccupied parking space. The user interface may include one or more filters for sorting the plurality of parking spaces. The one or more filters may be operated on the mobile device.

Step 150 can include calculating which unoccupied parking space in the plurality of parking spaces is located closest to the user. The user's location (i.e., GPS coordinates) may be obtained by the intelligent parking system, for example the user's location may be received from the mobile device. The intelligent parking system may calculate a distance between the user's location and each unoccupied parking space within the plurality of parking spaces. The unoccupied parking spaces may be sorted, for example by a sorting algorithm, from shortest to longest distance to the user. The sorting algorithm may output a shortest distance unoccupied parking space, which may be the desired parking solution. Step 150 may be repeated in an instance of the user deviating from a set of graphical directions for navigating to the shortest distance unoccupied parking space. In this manner, a change in the shortest distance unoccupied parking space may be identified. Step 150 may be repeated upon detection of a change in occupation status of at least one of the closest unoccupied parking space or an occupied parking space within the plurality of parking spaces that is closer to the user than the closest unoccupied parking space. In this manner, the intelligent parking system may recalculate which unoccupied parking space is the shortest distance unoccupied parking space upon a change in occupation status of one of the parking spaces.

Step 160 can include transmitting, to the mobile device of the user, graphical directions for use in navigating a vehicle of the user to the closest unoccupied parking space. The graphical directions may direct the user to the shortest distance unoccupied parking space and/or the user's selected parking space. In an instance of step 150 being repeated and if there is a change in the shortest distance unoccupied parking space, the intelligent parking system may transmit recalculated graphical directions to the mobile device of the user. The recalculated graphical directions may be used to navigate the user to the new shortest distance unoccupied parking space.

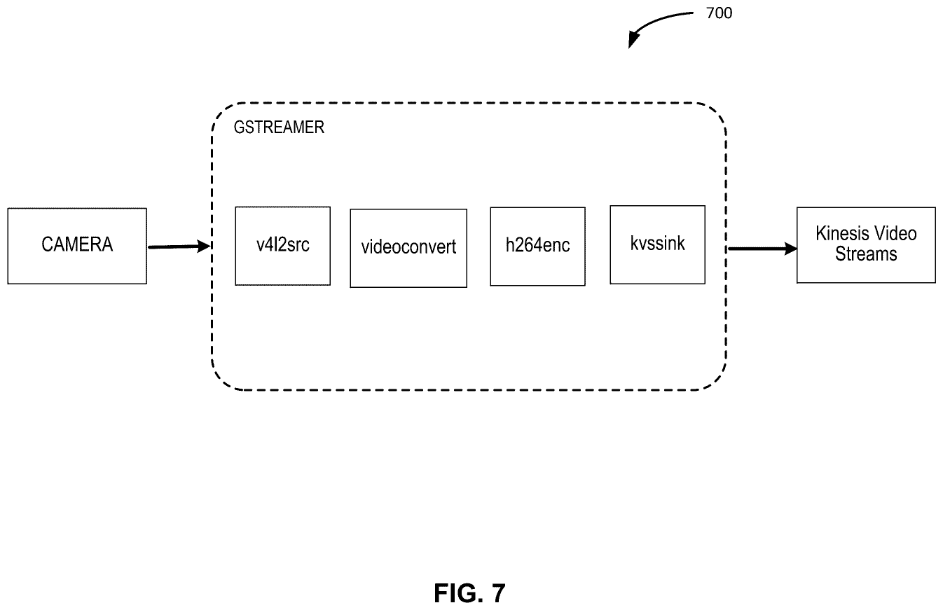

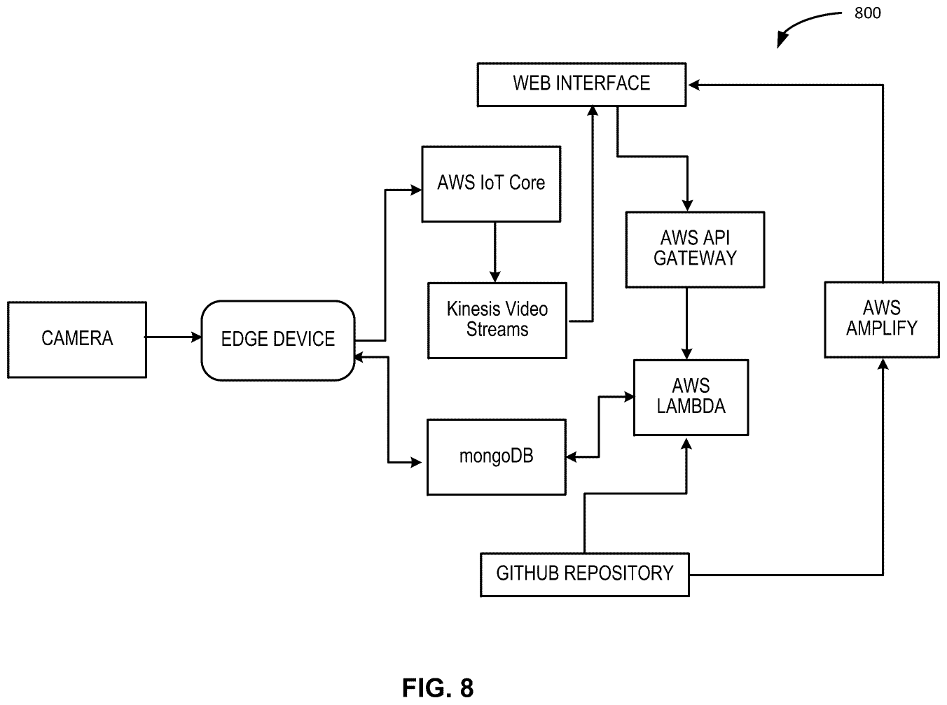

With reference to FIGS. 7 and 8, an exemplary data pipeline 700 and an exemplary software interface architecture 800 are provided. In various exemplary embodiments, system communication and web interface design may be hosted in the cloud. In this manner, the intelligent parking system may reduce network latency, throughput, and cost. The intelligent parking system may provide parking space occupation status determination results to MongoDB. The occupation status may be provided to users with a lambda microservice and React website. Two separate data pipelines may be utilized to reduce congestion and latency for occupation status determinations and video streaming. In this manner, data streams may be decoupled, which may decrease data updates and retrieval latency. Occupation status determinations may be performed on-site using an edge computer to further reduce latency and data updates. In this manner, the occupation status of a parking space is readily available at the edge, even without an internet connection.

Once the digital image and/or video reaches the edge device, for example by a wired connection, it may be optimized for video upload to the cloud. The digital image and/or video may be published to the user interface for user reference. The digital image and/or video resolution may be adjusted based on network performance. In an exemplary embodiment, a GStreamer component may be used to process the digital image and/or video before sending the digital image and/or video to the cloud. GStreamer may process the digital image and/or video in different stages and may optimize the digital image and/or video before sending the digital image and/or video to the cloud. GStreamer with video convert and h264enc components may be desirable for optimizing and converting video for publishing to the cloud. For example, GStreamer's video conversion may optimize the video resolution to 640×480 and may set the framerate to 30FPS. In this manner, average network latency may be reduced, for example by 4 seconds for HD video recorded with a GoPro camera. After being optimized and encoded, the digital image and/or video may be inserted into a kvssink queue to be published into kinesis video streams.

In various exemplary embodiments, Google Maps API may be used in creating a custom map and/or providing graphical directions. An API key may be obtained from Google, which may serve as the authentication mechanism for accessing Google's mapping services. After the API key is obtained, the map may be initialized on a web page using JavaScript, and parameters such as the map's center coordinates and zoom level may be adjusted to cater to a specific embodiment or application of the intelligent parking system. The initialization process may involve several steps. The HTML container, typically a <div> element, may act as the canvas for the map. Google Maps API may be loaded using a script tag with the API key. A new map object may be instantiated with options such as ‘center,’ ‘zoom,’ and ‘mapTypeId.’ The ‘center’ option may use latitude and longitude coordinates, while ‘zoom’ defines the map's initial zoom level. Defining the ‘center’ and the ‘zoom’ may enable the map to load correctly and align with user expectations. The parking lot layout may be overlayed onto the map, providing users with a graphical representation of available parking spaces. For example, the coordinates of parking spaces may be determined and the parking spaces may be represented by indicators and/or polygons. The map can be customized with different icons and labels, enhancing visual clarity and user interaction. Polygons may be defined using a series of latitude and longitude coordinates to outline parking areas, driveways, entrances, exits, and pedestrian pathways. The overlay contributes to the user experience by integrating desired spatial information into the map. Generating a real-time route map to the parking lot involves obtaining the starting point (i.e., the user's location) and destination (i.e., the shortest distance unoccupied parking space). The user's location information may be acquired using the Google Maps Geolocation API, which may utilize the mobile device's GPS to determine the user's coordinates. The database may provide information about unoccupied parking spaces. The Google Maps Directions Service may calculate the shortest route from the user's location to the shortest distance unoccupied parking space and/or may provide graphical directions for use in navigating the route. The graphical directions may include visual, textual, or audio directions. The graphical directions may be recalculated based on traffic conditions and/or user feedback.

In an exemplary embodiment, a feed from the digital camera can be captured, converted, compressed, and uploaded to Kinesis Video Streams. The v412src element can capture video from the digital camera, while the video conversion and h264enc elements can scale and encode the video. The feed can be provided to kvssink and built from the CPP plugin for uploading AWS Kinesis Video Streams. The exemplary data pipeline can publish data to the cloud with a latency of between 2 and 4 seconds. REST API can drive the data that populates the user interface calls from the React website. The web interface can sends out user updates tailored to their desires in real time based on the intelligent parking system's monitoring of occupation status of the plurality of parking spaces. Web sockets for real-time viewing of updates may be implemented. REST API may provide efficient cost management. Utilizing GraphQL and REST may reduce calls to middleware, such as for example AWS Lambda API. The user interface may be configured to operate with any suitable API. The backend for the intelligent parking system may be provided in AWS lambda and may be connected to the React frontend using API Gateway. In this manner, primary computing that enhances the user experience may be moved to the client machine. The React website, marked as Web Interface, may connect to the backend system, Kinesis Video streams, and Google Location services.

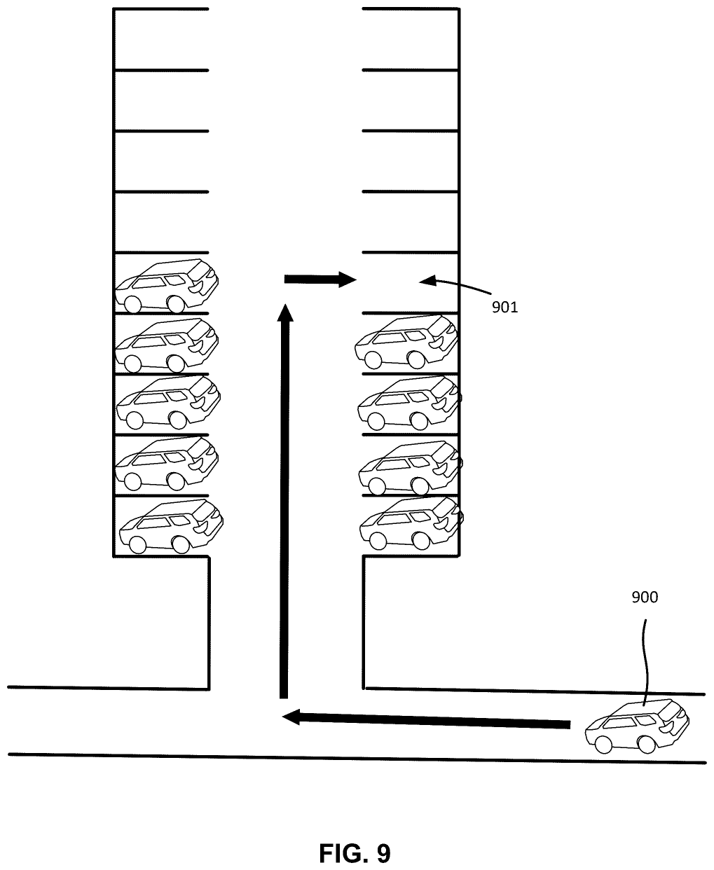

FIG. 9 illustrates exemplary real-time routing of a user's vehicle in an exemplary parking guidance system. Graphical directions are illustrated for use in navigating the user's vehicle 900 to the shortest distance unoccupied parking space 901. The graphical directions may be displayed on the mobile device and/or on the user interface.

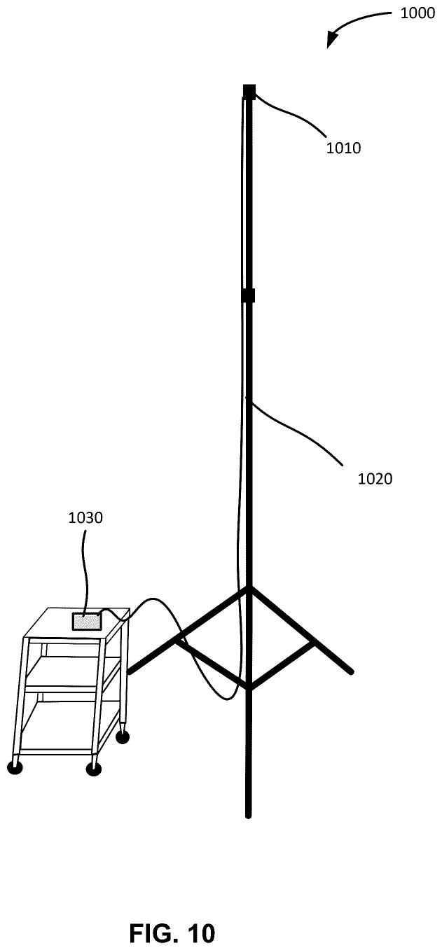

FIG. 10 illustrates an exemplary parking guidance system. Intelligent parking system 1000 can include a digital camera 1010, a camera mount 1020, and an edge computer 1030. Digital camera 1010 may be any suitable digital camera. By way of particular example, digital camera 1010 may be a GoPro Hero 10. The camera mount 1020 may be, for example, a tripod. The camera mount 1020 may be configured to provide the digital camera 1010 at a height and orientation sufficient to capture a digital image and/or video of a plurality of parking spaces. The edge computer 1030 may be any suitable computing device. By way of particular example, the edge computer 1030 may be an NVIDIA Jetson AGX Orin. The edge computer 1030 may be configured to perform one or more steps of any of the methods described herein. For example, the edge computer 1030 may be configured to determine whether a parking space is unoccupied.

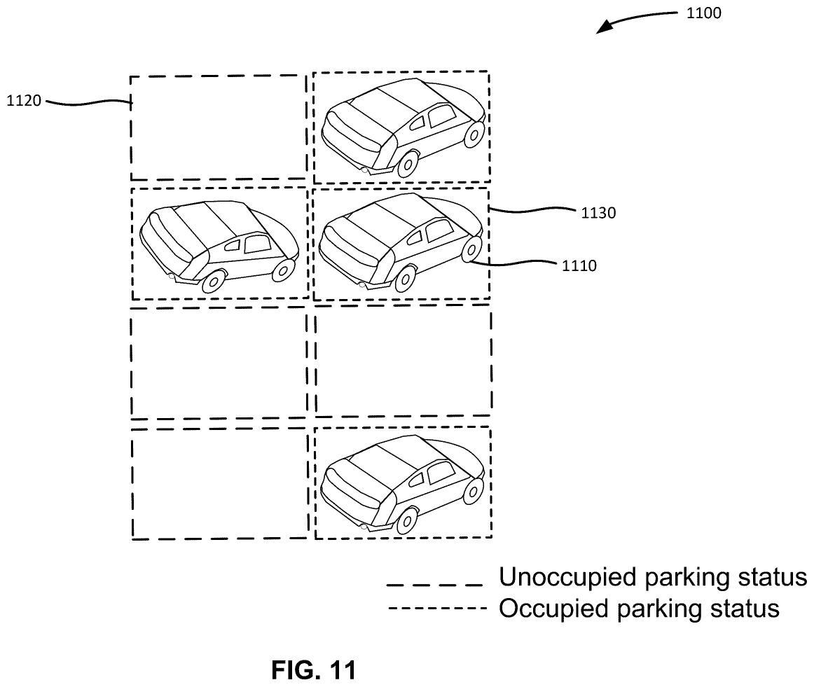

FIG. 11 illustrates an exemplary occupancy status chart 1100 in an exemplary parking guidance system. A plurality of parking spaces are illustrated. The occupancy status chart includes unoccupied parking spaces 1120 and occupied parking spaces 1130 (i.e., parking spaces having a car 1110 within them). The occupancy status chart 1100 may be contained within the database in graphical or data format and/or may be displayed on the user interface.

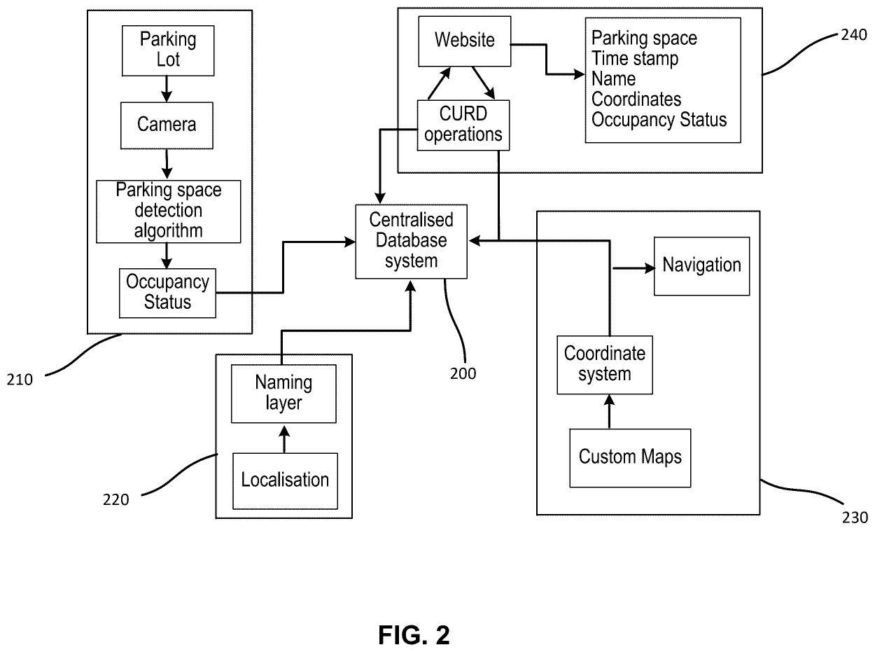

Referring now to FIG. 2, in an exemplary embodiment, the software architecture comprises five modules: detection module 210, localization module 220, navigation module 230, user interface module 240, and a centralized database system 200. However, any suitable architecture arrangement may be utilized, as desired.

In an exemplary embodiment, detection module 210 may be responsible for obtaining data on the vacancy of parking spaces and updating the database utilizing computer vision and machine learning techniques for car detection. Detection module 210 may include an imaging system including one or more digital cameras. Detection module 210 may identify and detect vehicles within the parking area through computer vision algorithms. Machine learning models may be employed to enhance the accuracy of car detection. Once a vehicle is detected, detection module 210 may update the status of the corresponding parking space in the centralized database system 200, indicating whether it is occupied or unoccupied. Integration of computer vision and machine learning within detection module 210 enables real-time monitoring and management of parking spaces, contributing to efficient parking space utilization. Detection module 210 may produce an output, such as occupancy status chart 1100, which visualizes the occupancy status of the parking spaces.

In an exemplary embodiment, localization module 220 may retrieve data regarding unoccupied parking spaces along with their respective coordinates. Localization module 220 may then employ a suitable approach, such as a Google API, to determine the distance between the parking spaces and the parking lot's entry point. In this manner, localization module 220 identifies the nearest available parking space. Based on this calculation, localization module 220 offers the user their preferred parking space, thus facilitating efficient parking space selection. The localization module 220 may provide a list of all unoccupied parking spaces and optionally the corresponding location, to the centralized database system 200.

In an exemplary embodiment, navigation module 230 utilizes a suitable approach, such as the Google API, to generate real-time navigation directions from the user's current location to a selected parking space, such as the shortest distance unoccupied parking space. Navigation module 230 may overlay a custom parking lot map, such as a custom parking lot map described above. Navigation module 230 may obtain the location data, such as the coordinates, of a chosen parking space from the centralized database system 200. Navigation module 230 enables navigation to a chosen parking space from the current location and identifies and guides users to the nearest available parking space within the parking lot based on their current location. Navigation module 230 may create graphical directions for navigating to the chosen parking space, and may display the graphical directions by user interface 240.

In an exemplary embodiment, the user interface 240 serves as the gateway for user interaction with the system. User interface 240 may provide a graphical interface through which users can access various features and functionalities of the system. User interface 240 may include visual elements, controls, and interaction mechanisms to facilitate user engagement and ease of use of the intelligent parking system. User interface 240 may include components such as a parking space availability visualization (i.e., occupancy status chart 1100), navigation integration such as incorporation of map services to provide directions from the user's current location to their chosen parking spaces, live updates such as real-time display of information concerning parking space availability, navigation routes, and relevant details like distance, availability status, and coordinates, user preference customization such as options for users to personalize their experiences, including suggestions for preferred parking spaces based on availability. However, any suitable user interface components, graphical user interfaces, and the like may be utilized, as desired. A user may select a desired parking space or the suggested parking space (i.e., shortest distance unoccupied parking space) through the user interface 240.

In an exemplary embodiment, the centralized database system 200 may be the repository for parking space data within the parking lot. Queries from the other four modules may trigger interactions with this database to retrieve and update relevant information. Centralized database system 200 may store details such as parking spaces'coordinates, distance from the parking lot entry point, and occupancy status. The intelligent parking system may use the centralized database system 200 to manage all data related to parking operations.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. When language similar to “at least one of A, B, or C” or “at least one of A, B, and C” is used in the claims or specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. An intelligent parking method, comprising:
detecting, by an intelligent parking system, a plurality of parking spaces contained in a digital image of a parking lot;
creating, by the intelligent parking system, a database containing entries for each of the plurality of parking spaces contained in the digital image;
determining, by the intelligent parking system, which parking spaces in the plurality of parking spaces are unoccupied;
receiving, by the intelligent parking system and from a mobile device of a user, a request for an unoccupied parking space;
calculating, by the intelligent parking system, which unoccupied parking space in the plurality of parking spaces is located closest to the user; and
transmitting, by the intelligent parking system and to the mobile device of the user, graphical directions for use in navigating a vehicle of the user to the closest unoccupied parking space;
wherein the intelligent parking system is computer-based.

2. The method of claim 1, wherein the detecting utilizes a polygon-point intersection algorithm.

3. The method of claim 1, wherein the database contains information regarding a latitude and a longitude of each parking space.

4. The method of claim 1, wherein the database contains position information for each parking space relative to a digital camera that produced the digital image.

5. The method of claim 1, wherein the graphical directions comprise Google Maps API information.

6. The method of claim 1, wherein the graphical directions comprise an overlay of parking lot information onto the digital image of the parking lot.

7. The method of claim 1, wherein the determining utilizes a machine learning algorithm.

8. The method of claim 1, further comprising updating the database to reflect the closest unoccupied parking space is now occupied by the vehicle.

9. The method of claim 1, wherein each entry in the database comprises a unique identifier associated with each parking space.

10. The method of claim 1, wherein the graphical directions are based, at least in part, on a presence of non-parked vehicles other than the vehicle of the user within the parking lot.

11. The method of claim 1, wherein the graphical directions are provided such that the vehicle of the user and another non-parked vehicle do not follow overlapping paths.

12. The method of claim 1, further comprising receiving, by the intelligent parking system, the digital image of the parking lot from an imaging system.

13. The method of claim 12, wherein the imaging system comprises a plurality of digital cameras.

14. The method of claim 13, wherein each of the plurality of digital cameras provides a respective digital image to the intelligent parking system and wherein the detecting the plurality of parking spaces and the determining which parking spaces in the plurality of parking spaces are unoccupied is based on each of the digital images.

15. The method of claim 14, wherein the determining comprises:
determining, by the intelligent parking system, a first distance from a first of the plurality of digital cameras to a parking space of the plurality of parking spaces;
calculating, by the intelligent parking system, a first weight based on the first distance;
assigning, by the intelligent parking system, the first weight to the first of the plurality of digital cameras;
determining, by the intelligent parking system, a second distance from a second of the plurality of digital cameras to the parking space;
calculating, by the intelligent parking system, a second weight based on the second distance;
assigning, by the intelligent parking system, the second weight to the second of the plurality of digital cameras;
generating, by the intelligent parking system, a first indication of whether the parking space is unoccupied based on a first digital image provided by the first of the plurality of digital cameras;
generating, by the intelligent parking system, a second indication of whether the parking space is unoccupied based on a second digital image provided by the second of the plurality of digital cameras; and
determining, based on the first indication, the first weight, the second indication, and the second weight, whether the parking space is unoccupied.

16. The method of claim 15, wherein the determining further comprises:
modifying the first indication by the first weight to create a modified first indication;
modifying the second indication by the second weight to create a modified second indication; and
calculating a weighted average indication of whether the parking space is unoccupied based on the modified first indication and the modified second indication.

17. The method of claim 1, wherein the calculating comprises:
determining, by the intelligent parking system, a distance from the user to each unoccupied parking space in the plurality of parking spaces;
sorting, by the intelligent parking system, each unoccupied parking space in the plurality of parking spaces by the distance; and
selecting, by the intelligent parking system, the unoccupied parking space which is closest to the user.

18. The method of claim 1, further comprising:
receiving, by the intelligent parking system and from the mobile device of the user, an indication that the user has deviated from the graphical directions;
recalculating, by the intelligent parking system, which unoccupied parking space in the plurality of parking spaces is located closest to the user; and
transmitting, by the intelligent parking system and to the mobile device of the user, recalculated graphical directions for use in navigating the vehicle of the user to the closest unoccupied parking space.

19. The method of claim 1, further comprising:
detecting, by the intelligent parking system, a change in an occupation status of at least one of the closest unoccupied parking space or an occupied parking space within the plurality of parking spaces that is closer to the user than the closest unoccupied parking space;
recalculating, by the intelligent parking system, which unoccupied parking space in the plurality of parking spaces is located closest to the user; and
transmitting, by the intelligent parking system and to the mobile device of the user, recalculated graphical directions for use in navigating the vehicle of the user to the unoccupied parking space which is located closest to the user.

20. A system for facilitating parking, comprising:
a digital camera configured to provide a digital image of a plurality of parking spaces;
an intelligent parking system, comprising one or more non-transitory, tangible computer readable storage mediums having instructions stored thereon that, in response to execution by one or more processors, cause the one or more processors to:
detect the plurality of parking spaces contained in the digital image;
create a database containing entries for each of the plurality of parking spaces contained in the digital image;
determine which parking spaces in the plurality of parking spaces are unoccupied;
receive, from a mobile device of a user, a request for an unoccupied parking space;
calculate which unoccupied parking space in the plurality of parking spaces is located closest to the user; and
transmit, to the mobile device of the user, graphical directions for use in navigating a vehicle of the user to the closest unoccupied parking space.
